(19) United States
(12) Patent Application Publication
(10) Pub. No.: US 2005/0274771 A1
(43) Pub. Date: Dec. 15, 2005

(54) Bonding apparatus

(75) Inventors: Osamu Kakutani, Oume-shi (JP); Toru Maeda, Tachikawa-shi (JP)

Correspondence Address: KODA & ANDROLIA, 2029 CENTURY PARK EAST, SUITE 1140, LOS ANGELES, CA, 90067, US

(73) Assignee: Kabushiki Kaisha Shinkawa

(21) Appl. No.: 11/150,415

(22) Filed: Jun. 10, 2005

(30) Foreign Application Priority Data
Jun. 10, 2004 (JP) 2004-172895

(51) Int. Cl. B23K 37/00; B23K 5/00

(52) U.S. Cl. 228/49.1; 228/4.1; 228/6.2

(57) ABSTRACT

A bonding apparatus 10 including an X and Y motor parts 20 and 50, which have substantially the same construction, and a moving table 60, which can be moved in the XY plane by these motor parts. The X motor part 20 and Y motor part 50 are connected to the moving table 60 by joint mechanisms 42 and 52 that are rotatable. In the X and Y motor parts 20 and 50, the movable coils 30 of the movable elements 24 are shaft-supported by shaft-supporting mechanisms 36 so that these coils are rotatable about the Z axis, and the shaft-supporting mechanisms 36 are guided so as to be movable linearly in the X and Y axial directions respectively by a guide mechanism formed with guide rails 38 and linear guides 37.

### BACKGROUND OF THE INVENTION

1. Technical Field

The present invention relates to a bonding apparatus and more particularly to a bonding apparatus in which a bonding head is carried on a moving table that is driven by an X motor and a Y motor.

2. Description of the Related Art

In wire bonding apparatuses, die bonding apparatuses and the like, a mechanism for moving the bonding head that performs bonding work to arbitrary positions is required. The so-called stacked type XY table mechanism described in Japanese Patent Application Laid-Open (Kokai) No. 2002-329772 is known as a moving mechanism for the bonding head in conventional bonding apparatuses. In this stacked type XY table mechanism, an X table that is driven in the X direction by an X motor and a Y table that is driven in the Y direction by a Y motor are provided one on the other to be stacked. For example, the Y table that moves in the Y direction is provided on top of the X table that moves in the X direction, and a bonding head is mounted on top of the Y table. As a result, the bonding head is movable to arbitrary positions in the XY plane by driving the X motor and Y motor.

By thus using a stacked type XY table mechanism, it is possible to move the bonding head to arbitrary positions, so that bonding work can be performed; however, the stacked structure involves several problems.

For example, in cases where the Y table and bonding head are moved in the Y direction over the X table, the positions of the centers of gravity of the Y table and bonding head on the X table move as the Y table is moved. Thus, the distance between the position of the center of gravity of the table as a whole and the acting point of the driving force fluctuates according to the position of the Y table.

Furthermore, apart from the problem of a shift in the position of the center of gravity in the XY plane and the acting point of the driving force, in the stacked structure is used, it is difficult to cause the driving force to act on the position of the center of gravity in the Z direction.

Thus, in a bonding apparatus that uses the stacked type XY table mechanism of the prior art, the position of the center of gravity of the moving table on which the bonding head is mounted and the acting point of the driving force of the driving motors deviate or fluctuate. As a result, there may be insufficient transmission of the driving force; furthermore, excessive vibration or excessive deformation may occur, thus interfering with the high-speed driving or high-precision positioning of the bonding head.

### BRIEF SUMMARY OF THE INVENTION

Accordingly, it is an object of the present invention to provide a bonding apparatus that allows an increase in the movement speed of a bonding head in a bonding apparatus.

It is another object of the present invention to provide a bonding apparatus in which the positioning precision of the bonding head is further improved.

The above objects are accomplished by a unique structure of the present invention for a bonding apparatus that includes a moving table, which is movable arbitrarily in the XY plane on a base by the driving of an X motor and by the driving of a Y motor, and a bonding head, which is mounted on this moving table, and in the present invention:
the X motor includes an X fixed element which is disposed on the base, an X movable element whose tip end is shaft-supported on an X joint portion disposed on the moving table, and which is driven in the X direction in cooperation with the X fixed element, an X shaft-supporting portion which shaft-supports the X movable element so that this X movable element is rotatable about the Z axis, and an X guide portion which guides the X shaft-supporting portion so that this X shaft-supporting portion is movable linearly in the direction of the X axis while supporting the X movable element via the X shaft-supporting portion, and the Y motor includes a Y fixed element which is disposed on the base, a Y movable element whose tip end is shaft-supported on a Y joint portion disposed on the moving table, and which is driven in cooperation with the Y fixed element, a Y shaft-supporting portion which shaft-supports the Y movable element so that this Y movable element is rotatable about the Z axis, and a Y guide portion which guides the Y shaft-supporting portion so that this Y shaft-supporting portion is movable linearly in the direction of the Y axis while supporting the Y movable element via the Y shaft-supporting portion.

In the bonding apparatus of the present invention, it is preferable that at least one selected from the group consisting of the X joint portion, Y joint portion, X shaft-supporting portion and Y shaft-supporting portion have a shaft-supporting mechanism in which two plate springs are disposed substantially perpendicular to each other, and both end portions of the respective plate springs are respectively connected to two objects of shaft-supporting so that such two objects of shaft-supporting are provided with freedom only in the rotational direction (or so that such two objects are disposed so as to be rotatable).

Furthermore, in the bonding apparatus of the present invention, it is preferable that the bonding apparatus comprise a rotation regulating mechanism that regulates the rotation of the moving table with respect to the base.

Furthermore, in the bonding apparatus of the present invention, it is preferable that the bonding apparatus comprise a fluid supporting mechanism that fluid-supports the moving table on the base.

In addition, it is preferable that the X joint portion and Y joint portion be disposed substantially in the position of the center of gravity of the moving table including the bonding head.

Furthermore, in the bonding apparatus of the present invention, it is preferable that the axial direction of the X motor have an inclination of approximately +45 degrees with respect to the axial direction of the neutral position of the bonding head in the XY plane, and the axial direction of the Y motor have an inclination of approximately −45 degrees with respect to this axial direction of the above-described neutral position.

In the above-described construction of the present invention, the X movable element of the X motor is movable linearly in the direction of the X axis while being shaft-supported so that this X movable element is rotatable about the Z axis, and the tip end of this X movable element is shaft-supported on the moving table so that this X movable element is rotatable. Furthermore, the Y movable element of the Y motor is movable linearly in the direction of the Y axis while being shaft-supported so that this Y movable element is rotatable about the Z axis, and the tip end of this Y movable element is shaft-supported on the moving table so that this Y movable element is rotatable. In this structure, only a single moving table is provided, and the tip end of the X movable element and tip end of the Y movable element are respectively shaft-supported on this single moving table. For example, when the X movable element is driven in the X direction, the tip end of this X movable element moves over the moving table in the X direction; and in this case, the Y movable element rotates as a result of the rotational function of the Y joint portion that is shaft-supported on the moving table, and the Y shaft-supporting portion, so that the Y movable element can follow the movement of the moving table. The same action occurs when the Y movable element is driven in the Y direction.

Accordingly, a single moving table is moved to an arbitrary position in the XY plane by being driven by an X motor and a Y motor, without providing an X table driven by an X motor and a Y table driven by a Y motor one on the other as in the prior art. Since there is only a single moving table, the position of the center of gravity of the table that includes the bonding head that is mounted on this table is fixed, so that there is no fluctuation in the distance between the acting point of the driving force of the X motor and the acting point of the driving force of the Y motor. Accordingly, driving of the moving table is performed in a constantly stable manner, the movement speed of the bonding head increases, and the positioning precision further improves.

Furthermore, by using shaft-supporting parts in which two plate springs are disposed in substantially perpendicular directions so that two objects of shaft-supporting are provided with freedom only in the rotational direction (or so that such two objects are disposed so that they are rotatable), it is possible to accomplish a shaft-supporting by a simple structure.

Furthermore, since a rotation regulating mechanism is provided, it is possible to regulate the rotation of the moving table with respect to the base.

Furthermore, since a fluid support mechanism is provided, the moving table can be fluid-supported on the base. Thus, the moving load of the moving table decreases, and it is possible to increase the movement speed of the bonding head and to improve the positioning precision.

Furthermore, since the place where the X motor is set with a shaft-supporting joint on the moving table and the place where the Y motor is set with a shaft-supporting joint on the moving table are set as approximately the position of the center of gravity of the moving table that includes the bonding head, the acting points of the driving forces and the position of the center of gravity substantially coincide, and the generation of excessive vibration and excessive deformation of such places can be suppressed.

Furthermore, in the present invention, the axial direction of the X motor and the axial direction of the Y motor have respective inclinations of approximately 45 degrees in opposite directions with respect to the axial direction of the neutral position of the bonding head. Accordingly, both the X motor and the Y motor can cause a driving force to act symmetrically on the bonding head, so that the apparent propulsion force with respect to the bonding head is a combined force of the X motor and Y motor and can be set at approximately 1.4 times the propulsion force of a single motor. Here, the axial direction of the neutral position of the bonding head refers to the direction of the long axis of the bonding head (though the bonding head ordinarily having a long axis) in a neutral state in which no driving force is received from the X motor or Y motor.

### BRIEF DESCRIPTION OF THE SEVERAL VIEWS OF THE DRAWINGS

FIG. 1 is a structural diagram of the bonding apparatus according to one embodiment of the present invention;

FIG. 2 is a top view of the mechanism section of the bonding apparatus in the embodiment of the present invention,

FIG. 3 is a diagram showing a shaft-supporting structure in which two plate springs are disposed substantially at right angles to each other, thus providing two objects of shaft-supporting with freedom in the direction of rotation;

FIG. 4 is a view taken along the line 4-4 in FIG. 2; and

FIG. 5 shows a construction of the rotation regulating mechanism adapted to be used in the embodiment of the present invention.

### DETAILED DESCRIPTION OF THE INVENTION

An embodiment of the present invention will be described in detail below with reference to the accompanying drawings. Below, the bonding apparatus will be described as a wire bonding apparatus; however, the bonding apparatus may also be a die bonding apparatus, face-down bonding apparatus or the like.

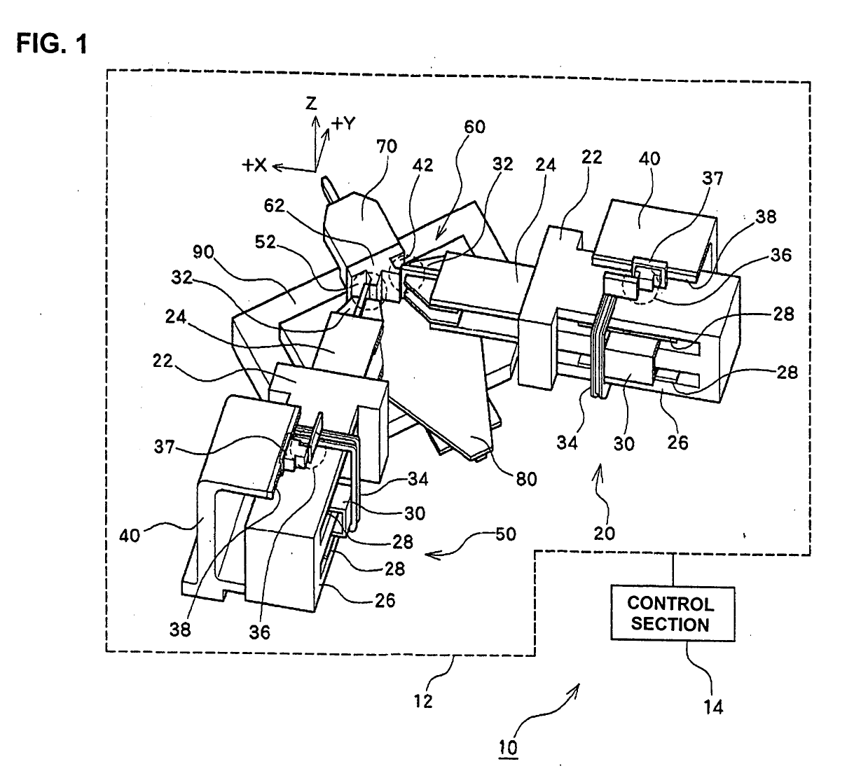

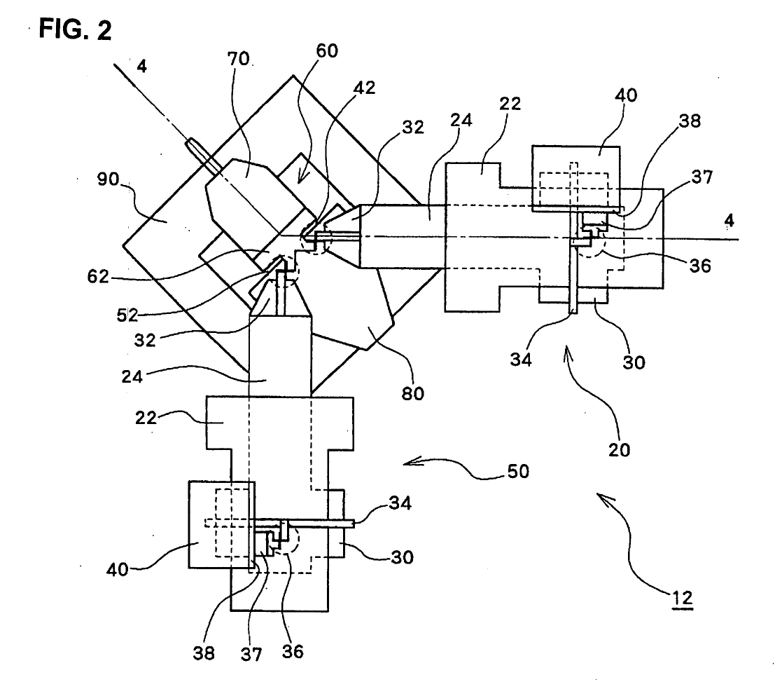

FIG. 1 is a structural diagram of the wire bonding apparatus 10. The wire bonding apparatus 10 comprises a mechanism section 12 that performs bonding work, and a control section 14 that controls the overall operations of the respective elements of the mechanism section 12. The control section 14 further causes specified bonding work to be performed using a bonding head 70 mounted on a moving table 60. FIG. 2 is a top view of the mechanism section 12.

In FIGS. 1 and 2, the mechanism section 12 is constructed so that this section includes an X motor part (or “X motor”) 20, a Y motor part (or “Y motor”) 50, a moving table 60 which is movable in the XY plane by being driven by the X motor part 20 and Y motor part 50, and a base 90 which supports the moving table 60 via a fluid.

The X motor part 20 and Y motor part 50 are respectively comprised of linear motors that have substantially the same constituent elements, and the tip ends of the movable elements of these motor parts are respectively connected to the moving table 60. The X and Y motor parts 20 and 50 function to move the moving table 60 and bonding head 70 to arbitrary positions in the XY plane by controlling the driving of the X motor part 20 and Y motor part 50.

The X motor part 20 and Y motor part 50 are substantially the same except for the fact that the tip end connecting positions with the moving table 60 are different; accordingly, the same constituent elements are labeled with the same symbols. Accordingly, though the construction of the X motor part 20 will be described mainly below, the phrase “X direction” and the like can be replaced with and read on “Y direction” and the like for the construction of the Y motor part 50.

The X motor part 20 comprises a fixed element 22 and a movable element 24, and the fixed element 22 includes a yoke 26 and a permanent magnet 28. The movable element 24 includes a movable coil 30 which is disposed so that this coil cuts across the magnetic flux formed by the yoke 26 and permanent magnet 28 of the fixed element 22, and the movable element 24 further includes a tip end 32 that is connected to the movable coil. The movable coil 30 is connected to a driving circuit which is not shown in the drawings, so that a driving current flows through the movable coil 30 in accordance with a driving signal from the control section 14, thus interacting with the magnetic flux formed by the fixed element 22, so that a driving force is provided in the X direction shown in FIG. 1.

A movable ring 34 is connected to the outside of the movable coil 30. The movable ring 34 is a ring member, and it has a shape that surrounds the outer circumference of the yoke 26 of the fixed element 22 in a plane perpendicular to the direction of the long axis of this yoke 26, i.e., in the YZ plane shown in FIG. 1. The movable ring 34 is attached to the outer circumference of the movable coil 30 by fastening means such as an adhesive material or the like. Accordingly, the movable ring 35 is moved together with the movable coil 30.

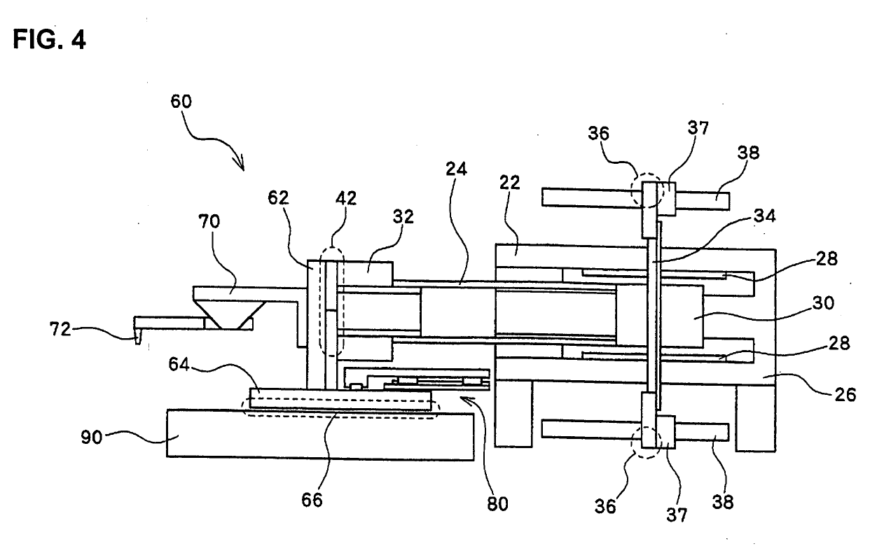

Disposed on the outside of the fixed element 22 is a guide rail stand 40 that has guide rails 38 that extend in the X direction. The guide rail stand 40 is disposed in a constant fixed dispositional relationship with the fixed element 22. The guide rails 38 are disposed on the upper side and lower side (the guide rail on the lower side not shown in FIG. 1 but partially shown in FIG. 4) of the fixed element 22, and they have the function of guiding a linear guide 37 so that the linear guide 37 is movable in the X direction.

A shaft-supporting mechanism 36 is disposed between the linear guide 37 and the movable ring 34. The shaft-supporting mechanism 36 is a rotating connecting part that has the function of connecting the movable ring 34 to the linear guide 37 and supporting the movable ring 34 so that this movable ring is rotatable about the Z axis. Accordingly, as a result of the action of the shaft-supporting mechanism 36, the movable ring 34 is rotatable about the Z axis while advancing linearly in the X direction along the linear guides 37. Since the movement of the movable ring 34 is the same as the movement of the movable coil 30, i.e., the movable element 24, the movable element 24 is rotatable about the Z axis while advancing linearly in the X direction.

The tip end 32 of the movable element 24 has the function of transmitting the movement of the movable coil 30 to the moving table 60. The tip end 32 can be constructed as a plate member or the like which is connected to the movable coil 30 and extends toward the moving table 60 via an opening in the front surface of the fixed element 22. The movable element 24 and moving table 60 are connected by a joint mechanism 42 so that they are rotatable about the Z axis shown in FIG. 1. In other words, the joint mechanism 42 is the same as the shaft-supporting mechanism 36.

In FIGS. 1 and 2, the connected portion between the tip end 32 of the movable element 24 of the X motor part 20 and the moving table 60 is shown as the joint mechanism 42, and the connected portion between the tip end 32 of the movable element 24 of the Y motor part 50 is shown as the joint mechanism 52.

It is preferable that the joint mechanism 42 of the X motor part 20 and the joint mechanism 52 of the Y motor part 50 be disposed as close as possible to the position of the center of gravity of the overall moving table including the bonding head 70.

Furthermore, as shown in FIG. 2, it is preferable that the axial direction of the bonding head 70 be set at substantially the same inclination with respect to the axial direction of the X motor part 20 and the axial direction of the Y motor part 50 when the bonding head 70 is in a neutral position. Ordinarily, the bonding head has a long slender arm with a capillary attached to the tip end as shown in FIGS. 1 and 2, and the positional coordinate system of the bonding head is usually considered with the long axis of this arm as a reference. The axial direction of the bonding head in the neutral position refers to the direction of the long axis of the bonding head, i.e., the direction of the long axis of the arm, in a neutral state in which no driving force is received from the X motor or Y motor. In other words, it is preferable that the axial direction of the X motor part 20 have an inclination of +45 degrees with respect to the direction of the long axis of the long slender arm of the bonding head 70, and that the axial direction of the Y motor part 50 have an inclination of −45 degrees with respect to the direction of this long axis. With this structure, the acting point of the driving force of the X motor part 20 and the acting point of the driving force of the Y motor part 50 is caused to coincide substantially with the position of the center of gravity of the moving table 60 as a whole including the bonding head 70 that is to be moved. Furthermore, since the bonding operation consists mainly of disposing wires in the direction of the long axis of the bonding head 70 and the direction perpendicular to this direction of the long axis, the propulsion force that is applied to the bonding head becomes the combined force of the driving force of the X motor part 20 and the driving force of the Y motor part 50 as a result of the directions of the driving forces of the X motor part 20 and Y motor part 50 being respectively rotated by 45 degrees with respect to the direction of the long axis of the bonding head 70, so that approximately 1.4 times the propulsion force of a single motor part is obtained.

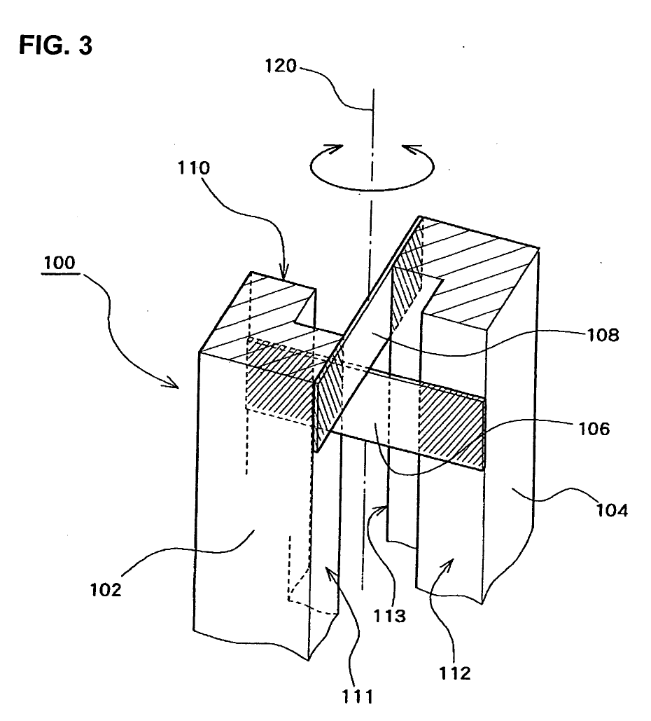

For the shaft-supporting mechanism 36 and joint mechanisms 42 and 52, a general rotating shaft-supporting mechanism comprising a combination of a shaft and a hole or the like can be employed. FIG. 3 is a diagram that shows an example of the rotating shaft-supporting mechanism that uses a shaft-supporting mechanism 100 in which two plate springs are disposed substantially perpendicular to each other, and both ends of the respective plate springs are respectively fastened to two objects of shaft-supporting, so that such two objects of shaft-supporting are provided with freedom only in the rotational direction (so that such two objects of shaft-supporting are disposed so that they are rotatable). Such a mechanism is sometimes called a “cross pivot mechanism.”

The shaft-supporting mechanism 100 shown in FIG. 3 is designed so that it connects two objects 102 and 104 that are to be moved in terms of relative rotation only (or so that two objects 102 and 104 make a rotating movement only) using two plate springs 106 and 108.

More specifically, in this structure of FIG. 3, the two plate springs 106 and 108 are disposed so as to form an angle of approximately 90 degrees relative to each other, and connecting surfaces 110, 111, 112 and 113 that are in a perpendicular relationship are formed on the two objects 102 and 104 so that the surfaces are in connection with both end portions of the respective plate springs 106 and 108 that are perpendicular to each other.

Furthermore, in the first object 102, a connecting surface 110 on first side and a connecting surface 111 on the second side are perpendicular to each other; and in the second object 104, a connecting surface 112 on first side and a connecting surface 113 on the second side are perpendicular to each other. Furthermore, the connecting surface 110 on the first side of the first object 102 and the connecting surface 112 on the first side of the second connecting object 104 are disposed so that these surfaces are parallel to each other, and the connecting surface 111 on the second side of the first object 102 and the connecting surface 113 on the second side of the second object 104 are disposed so that these surfaces are parallel to each other. With this positional relationship, one end of the first plate spring 106 is connected to the connecting surface 110 on the first side of the first object 102, and the other end is connected to the connecting surface 112 on the first side of the second object 104. Likewise, one end of the second plate spring 108 is connected to the connecting surface 111 on the other side of the first object 102, and the other end is connected to the connecting surface 113 on the other side of the second object 104.

With the above structure, the first object 102 and the second object 104 are given freedom only in rotation (or the objects are rotatable) about the axis 120 perpendicular to the plane at which the two spring plates 106 and 108 cross at right angles. By way of providing the shaft-supporting mechanisms 36 with this structure 100 shown in FIG. 3, if the first object 102 is the movable ring 34 and the second object 104 is the linear guide 37, then the shaft-supporting mechanisms 36 shown in FIGS. 1 and 2 respectively have a structure that is given freedom only in rotation (or a structure in which the movable ring 34 and the linear guide 37 are rotatable or are in a rotatable relationship with each other) by a simple structure. Furthermore, if the first object 102 is the tip end 32 of the movable element 24, and the second object 104 is the moving table 60, then the joint mechanisms 42 and 52 shown in FIGS. 1 and 2 respectively have a structure that is given freedom only in rotation (or a structure in which the tip end 32 and the moving table 60 are rotatable or are in a rotatable relationship with each other) by a simple structure.

Returning now to FIGS. 1 and 2, the moving table 60 is a table mounting the bonding head 70, which can be moved arbitrarily in the XY plane on the base 90. More concretely, the moving table 60 is driven by the tip end 32 of the movable element 24 of the X motor part 20 and the tip end 32 of the movable element 24 of the Y motor part 50. FIG. 4 is a sectional view taken along the line 4-4 in FIG. 2, showing the section in the direction of length of the X motor part 20, and the area around the moving table 60.

In this moving table 60, a stand 62 is caused to rise in a substantially vertical attitude on a plate-form table 64. The stand 62 is, at a portion of its surface, connected to the tip end 32 of the movable element 24 of the X motor part 20 by the joint mechanism 42. The stand 62 is attached at its tip end with a bonding head 70 that has a capillary 72 used for executing bonding work. It is preferable that the joint mechanism 42 be disposed in the vicinity of the three-dimensional position of the center of gravity of the moving table 60 as a whole including the bonding head 70. More specifically, it is preferable that the joint mechanism 42 be disposed not only in the vicinity of the position of the center of gravity in the XY plane, but also in the vicinity of the position of the center of gravity in the Z direction. With this structure, it is possible to cause the acting point of the driving force of the X motor part 20 and the acting point of the driving force of the Y motor part 50 to coincide substantially with the three-dimensional position of the center of gravity of the moving table 60 as a whole including the bonding head 70 that is to be moved; and as a result, a high speed movement and a high-precision positioning of the bonding head 70 are possible.

The plate-form table 64 is movable in the XY plane while being caused to float above the base 90 by a fluid support mechanism 66. It is preferable that both the undersurface of the plate-form table 64 where the fluid support mechanism 66 is formed and the upper surface of the base 90 be formed flat. Furthermore, in the fluid support mechanism 66, a pressurized gas from a gas pressure generator (not shown) is supplied to the gap between the base 90 and the plate-form table 64, so that the plate-form table 64 floats upward with respect to the base 90, while the gap between the base 90 and the plate-form table 64 is maintained as an appropriate gap by applying suction to this gap by means of a vacuum apparatus (not shown). With the use of this fluid support mechanism 66, it is possible to lighten the load on the moving table and to achieve high-precision positioning.

The moving table 60 includes a rotation regulating mechanism 80 that regulates the moving table 60 so that the moving table 60 does not rotate in the XY plane.

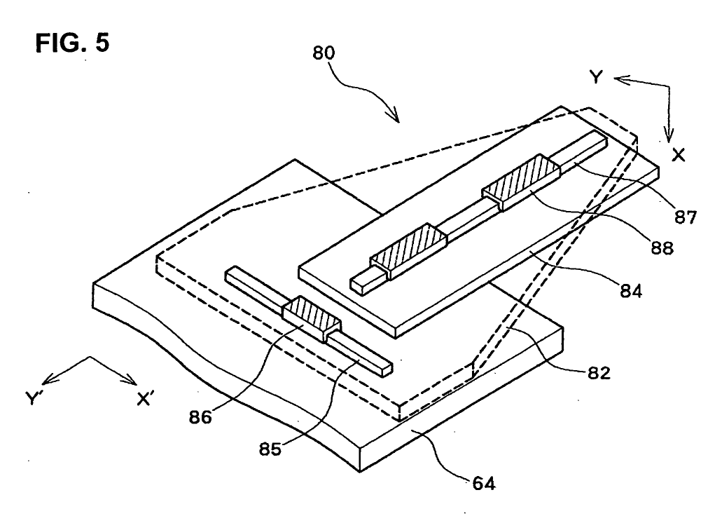

FIG. 5 shows the concrete structure of the rotation regulating mechanism 80. Since the axial direction of the X motor part 20 and the axial direction of the Y motor part 50 are inclined by approximately 45 degrees with respect to the axial direction of the bonding head 70, regulation of the rotation of the moving table 60 will be described in FIG. 5 using the X′ direction and Y′ direction which are inclined by 45 degrees from the X direction and Y direction in FIG. 1. The rotation regulating mechanism 80 includes an upper regulating plate 82 and a lower regulating plate 84, so that only movement in the X′ direction shown in FIG. 5 is allowed between the plate-form table 64 of the moving table 60 and the upper regulating plate 82, and only movement in the Y′ direction shown in FIG. 5 is allowed between the upper regulating plate 82 and the lower regulating plate 84; and on the whole, the rotation regulating mechanism 80 allows only movement of the plate-form table 64 of the moving table in the X′ direction and Y′ direction, and thus performs a regulating function, so that no rotation of the moving table 60 occurs. The lower regulating plate 84 is disposed in a fixed position relation with the base 90.

More specifically, a guide rail 85 is disposed on the upper surface of the plate-form table 64 along the X′ direction; and corresponding to the guide rail 85, a linear guide 86 which has a guide direction in the X′ direction is disposed on the undersurface of the upper regulating plate 82. Likewise, a guide rail 87 is disposed on the upper surface of the lower regulating plate 84; and corresponding to the guide rail 87, linear guides 88 which has a guide direction in the Y′ direction is disposed on the undersurface of the upper regulating plate 82. Thus, the rotation of the moving table 60 can be regulated.

In FIG. 1, the control section 14 has a movement control function that sends instructions of the X motor part 20, Y motor part 50, and Z motor (not shown) of the bonding head 70; and it causes the capillary 72 on the tip end of the bonding head 70 to move to arbitrary XYZ positions in order to perform bonding work. The control section 14 further has a function that provides energy, which is used for bonding, to the capillary from a transducer (not shown), a sequence processing function that processes these instructions according to a specified sequence, thus causing continuous bonding work to be performed, and the like. It is preferable that position information be fed back from a position sensor (not shown) when the movement control function is executed.

The operation of the bonding apparatus constructed as above will be described below. As one example, a case will be described in which the bonding head 70 is caused to move by an arbitrary amount ΔX in the +X direction shown in FIG. 1.

In this case, a driving signal corresponding to ΔX is first sent to a driving circuit (not shown) from the control section 14, and a driving current corresponding to ΔX is supplied from the driving circuit to the X motor part 20. More specifically, a driving current is supplied to the movable coil 30; and as a result, the movable element 24 is moved by +ΔX with respect to the fixed element 22. In other words, the tip end 32 of the movable element 24 causes the stand 62 of the moving table 60 to move by +ΔX via the joint mechanism 42. Since the plate-form table 64 is fluid-supported by the fluid supporting mechanism 66 together with the stand 62 under the regulation of the rotation regulating mechanism 80, the table 64 is smoothly moved by +ΔX while floating above the base 90.

When the above movement is made, the tip end 32 of the movable element 24 of the Y motor part 50 that is connected to the stand 62 by the joint mechanism 52 in a rotatable manner also attempts to move by +ΔX. However, since a movement command has not been sent to the Y motor part 50 from the control section 14, the movable element 24 of the Y motor part 50 can only rotate about the center of the shaft-supporting mechanism 36 of the Y motor part 50. More specifically, while the stand 62 of the Y motor part 50 is pushed in the +X direction, the movable element 24 of the Y motor part 50 rotates in the clockwise direction about the shaft-supporting mechanism 36 on the plane of the drawing sheet for FIG. 1. Accordingly, there is a slight positional deviation in the Y direction; in actuality, however, since the position command value and the actual position of the moving table 60 are constantly fed back by the position sensor, such deviation is immediately corrected, and the desired movement of (+ΔX, 0) is achieved.

The same as described above is true in a case where the bonding head 70 is moved by an arbitrary amount ΔY in the +Y direction shown in FIG. 1 by way of operating the Y motor part 50 via the control section 14. Furthermore, the X motor part 20 and Y motor part 50 can be operated simultaneously. In this way, the bonding head 70 can be moved to any arbitrary positions in the XY plane.

As described above, in the present invention, the X motor and Y motor are used, the movable elements of the respective motors are provided so as to be movable in the X and Y axial directions while supporting these elements to make rotations about the Z axis, and the tip ends of the movable elements of the respective motors are connected to the moving table by means of joints that allow rotation. Accordingly, it is possible to move a single moving table to arbitrary positions in the XY plane without using a stacked table structure. Furthermore, the acting points of the driving forces of the respective motor parts can be positioned in the vicinity of the position of the center of gravity of the moving table as a whole. Accordingly, transmission of the driving force can be accomplished efficiently, excessive vibration and deformation can be suppressed, and high-speed movement of the bonding head and high-precision positioning can be accomplished.

1. A bonding apparatus comprising a moving table, which is moveable arbitrarily in an XY plane on a base by an X motor and a Y motor, and a bonding head, which is mounted on said moving table, wherein
said X motor is comprised of:
an X fixed element which is disposed on the base,
an X movable element whose tip end is shaft-supported on an X joint portion disposed on the moving table and which is driven in an X direction in cooperation with the X fixed element,
an X shaft-supporting portion which shaft-supports an X movable element so that said X movable element is rotatable about a Z axis, and
an X guide portion which guides the X shaft-supporting portion so that said X shaft-supporting portion is movable linearly in a direction of an X axis while supporting the X movable element via the X shaft-supporting portion; and
said Y motor is comprised of:
a Y fixed element which is disposed on the base,
an Y movable element whose tip end is shaft-supported on a Y joint portion disposed on the moving table and which is driven in cooperation with the Y fixed element,
a Y shaft-supporting portion which shaft-supports the Y movable element so that said Y movable element is rotatable about a Z axis, and
a Y guide portion which guides the Y shaft-supporting portion so that said Y shaft-supporting portion is movable linearly in a direction of the Y axis while supporting the Y movable element via the Y shaft-supporting portion.

2. The bonding apparatus according to claim 1, wherein at least one of the X joint portion, Y joint portion, X shaft-supporting portion and Y shaft-supporting portion has a shaft-supporting mechanism in which two plate springs are disposed substantially perpendicular to each other, and both end portions of the respective plate springs are respectively connected to two objects of shaft-supporting so that said two objects are rotatable.

3. The bonding apparatus according to claim 1, further comprising a rotation regulating mechanism that regulates a rotation of the moving table with respect to the base.

4. The bonding apparatus according to claim 1, further comprising a fluid supporting mechanism that fluid-supports the moving table on the base.

5. The bonding apparatus according to claim 1, wherein the X joint portion and the Y joint portion are disposed substantially in a position of center of gravity of the moving table including the bonding head.

6. The bonding apparatus according to claim 1, wherein with respect to an axial direction of a neutral position of the bonding head in the XY plane:
an axial direction of the X motor has an inclination of approximately +45 degrees, and
an axial direction of the Y motor has an inclination of approximately −45 degrees.
